(19) United States
(12) Patent Application Publication
(10) Pub. No.: US 2006/0026467 A1
(43) Pub. Date: Feb. 2, 2006

(54) Method and apparatus for automatically discovering of application errors as a predictive metric for the functional health of enterprise applications

(76) Inventors: Smadar Nehab, Tel Aviv (IL); Gadi Entin, Hod Hasharon (IL); David Barzilai, Sunnyvale, CA (US); Yoav Cohen, Tel Aviv (IL)

Correspondence Address: GLENN PATENT GROUP, 3475 EDISON WAY, SUITE L, MENLO PARK, CA, 94025, US

(21) Appl. No.: 11/192,662

(22) Filed: Jul. 29, 2005

Related U.S. Application Data
(60) Provisional application No. 60/592,676, filed on Jul. 30, 2004.

(51) Int. Cl. G06F 11/00

(52) U.S. Cl. 714/38

(57) ABSTRACT

A method and apparatus that uses application errors as a predictive metric for overall measuring of applications functional health are disclosed. The automated system intercepts messages exchanged between inter-services of enterprise applications, analyzes the context of those messages, and automatically derives application errors embedded in the message. Thereafter, it is capable of showing deviations from expected behavior for the purposes of predicting failures of the monitored application. Furthermore, the invention displays the user's real-time actionable data generated using the application errors.

### CROSS REFERENCE TO RELATED APPLICATIONS

This application claims priority from U.S. Provisional Patent Application No. 60/592,676 filed on Jul. 30, 2004, the entire disclosure of which is incorporated herein by reference.

### BACKGROUND OF THE INVENTION

1. Technical Field

The invention relates generally to automated systems for monitoring the performance and functional health of enterprise applications more particularly, the invention relates to automated systems for monitoring application errors as a metric for overall application and functional health, as well as for the purpose of early notification of failures that result from those errors.

2. Discussion of the Prior Art

Messaging infrastructure, integration servers, Web services, and service oriented architectures (SOA), for many reasons, are being adopted today to integrate applications in enterprise information technology (IT). Existing implementations of SOA are based on message buses, e.g. IBM MQ, or application servers, e.g. BEA WebLogic that serve as the connection medium and the glue logic between the independent applications. SOA, independently of its implementations, significantly lowers application integration costs which, in many cases, are estimated to be a third of IT budgets. Such architecture further allows the enterprises to become more agile and adaptive because application development becomes easier.

SOA implementations dramatically change the way applications behave and operate within enterprise IT. These technologies break monolithic applications into a loosely-coupled application system, usually referred to as “enterprise applications” or “composite applications”. An enterprise application includes multiple services connected through messaging-based interfaces. This architecture enables cross application transactions that consist of messages that are communicated among services to perform a single business transaction. FIG. 1 shows an exemplary diagram of a simple SOA architecture 100 representing several independent services, each operating on a different platform. The services are all connected to each other through a messaging interface which, here for simplicity, is referred to as an enterprise service bus. Communication between services is performed by interchanging messages which have a well defined structure. These messages are transferred on top of communication protocols including, for example, simple object access protocol (SOAP), hypertext transfer protocol (HTTP), extensible markup language (XML), Microsoft message queuing (MSMQ), Java message service (JMS), IBM WebSphere MQ, and the like. An example of an enterprise application is a car rental system that may include a website which allows a customer to make vehicle reservations through the Internet, a partner system, such as airlines, hotels, and travel agents; and legacy systems, such as accounting and inventory applications.

Enterprises demand high-availability and performance from their enterprise applications. Hence, automated continuous monitoring of these applications is essential to ensure continuous availability and satisfactory performance. Specifically, the most critical performance factor in enterprise applications is the application availability. Traditionally application availability is determined according to the operation status of the application, i.e. whether the application is “up” or “down.” However, in many cases an application can be up, but still returns errors, and thus the application would not deliver the required service. In SOA environments, due to the dynamic nature of application usage by other applications, many of those errors are anticipated. Therefore, the application availability is the percentage of application service calls which do not return errors. For instance, Table I below shows error codes returned by a service call “GetQuote”. The returned error “19” means that the requested product is not available on location and, thus it is a legitimate usage error. However, error code “−1001” is a pure application error, which returned due to the inability of the backend service to execute. It can be easily claimed that each request that returned a “−1001” error, causes a pure revenue loss, simply due to application failures. As can be seen, the estimated revenue loss resulting from the error code “−1001” is around $2M per year.

TABLE I
Error Codes Returned

| | | | Estimated |
|---|---|---|---|
| | Service | Number of | revenue quote |
| Error Code | function | loss quotes | loss/yearly |
| 19 - product type | “GetQuote” | 13,173 | $2M |
| is not available at | | | |
| location | | | |
| −1001 | “GetQuote” | 11,370 | $2M |

In the related art, monitoring tools exist to measure resource-usage of such enterprise applications, or to drive synthetic transactions into these applications to measure their external performance and availability characteristics. These monitoring tools function to alert IT personnel within an enterprise to failures or poor performance. Specifically, these monitoring tools are mostly designed for measuring infrastructure performance and availability. However, other important metrics that are perceived as meaningless to IT personnel are not monitored, and thus the application behavior is not truly measured.

As an example, application errors comprise one metric that is not monitored by the monitoring tools known in the prior art. An application error is returned by the calling service and may result from a function, e.g. a SOAP function of a Web service or a response message to request message in a MQ environment; an application, e.g. a partner system; or an infrastructure, e.g. servers. Application errors returned by an application are meaningful to software developers and are generally used for debugging purposes. However, application errors, by themselves, are not understood by IT personnel and, thus, are not used for system health monitoring. Nevertheless, application errors (or bugs) have a huge part as a cause of IT application failures and in affecting IT health in general. In many cases, errors between the services can serve as predictive indicators, if only they were monitored.

It would be, therefore, advantageous to provide a solution that discovers application errors and that uses them as a health metric, as well as a predictive metric for providing early notifications of failures of the monitored enterprise system.

### SUMMARY OF THE INVENTION

A method and apparatus that uses application errors as a predictive metric for overall monitoring of applications functional health are disclosed. The automated system intercepts messages exchanged between services or applications components of enterprise applications, analyzes the context of those messages, and automatically discovers application errors embedded in the message. Thereafter, it is capable of showing deviations from expected behavior for the purposes of predicting failures of the monitored application. Furthermore, the invention provides the user with real-time actionable data and the context of the errors, thus allowing fast root cause and recovery.

### BRIEF DESCRIPTION OF THE DRAWINGS

FIG. 1 is an exemplary diagram of a typical system architecture for executing a composite application (prior art);

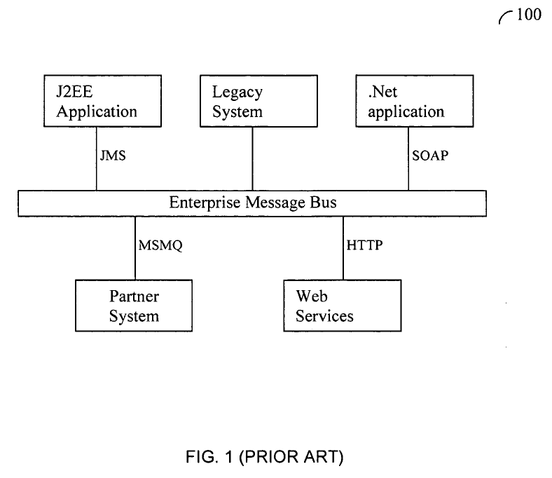

FIG. 2 is a block diagram of an automated monitoring system disclosed in accordance with the invention;

FIG. 3 is an exemplary screenshot of a matrix view that shows a summary baseline of applications errors in context of transactions;

FIG. 4 is an exemplary screenshot of a deviation graph view;

FIG. 5 is another exemplary screenshot of a deviation graph view;

FIG. 6 is an exemplary screenshot of a bar graph showing the application availability; and

FIG. 7 is flowchart of a method for using application errors as a predictive metric according to the invention

### DETAILED DESCRIPTION OF THE INVENTION

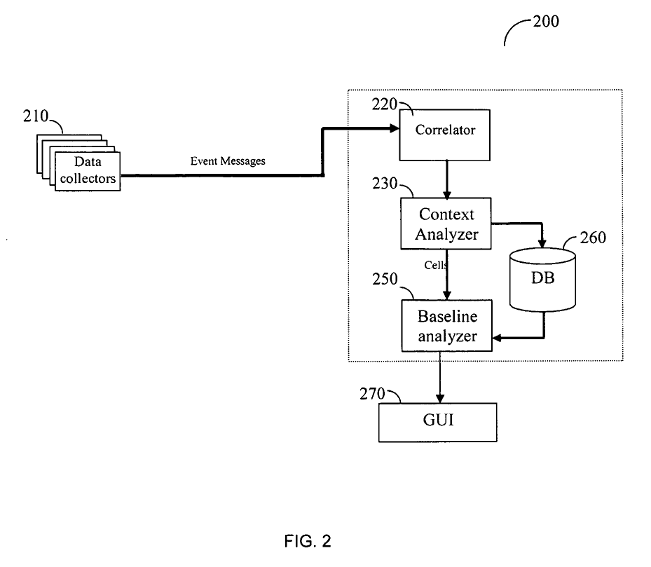

FIG. 2 is an exemplary block diagram of an automated monitoring system 200 according to the invention. The system 200 comprises a plurality of data collectors 210, a correlator 220, a context analyzer 230, a baseline analyzer 250, a database 260, and a graphical user interface (GUI) 270. The data collectors 210 are deployed on the services or applications that they monitor, or on the network between these applications as a network appliance, and are designed to capture messages that are passed between the various services. The data collectors 210 are non-intrusive, i.e. they do not to impact the behavior of the monitored services. The data collectors 210 can capture messages transmitted using communication protocols including, but not limited to, SOAP, XML, HTTP, JMS, MSMQ, and the like.

The correlator 220 classifies raw objects received from the data collectors 210 into events. Each event represents a one-directional message as collected by a single collector 210. Each event includes one or more dimension values, as generated by the collectors 210 from the original message data. The dimension values are based on the dimensions of interest, as defined by the users. For example, to extract an application error code it is necessary to define at least one error dimension and analyze each response message generated by the application.

The context analyzer 230 analyzes streams of events that are provided in a canonical representation. This representation can be thought of as a set of name-value pairs. Each such pair represents dimension and dimension value and, thus, defines the context to be derived for the event. A canonical message structure can be represented as follows:
{<DIM1, DV1>, <DIM2, DV2>, <DIM3, DV3>, . . . , <DlMn, DVn>}

During the system 200 setup, users may define the tuple schemas of interest for context monitoring. A tuple schema is a n-dimensional cube of dimensions. Following are examples for tuple schemas that are defined using dimensions
DIM1, DIM2, and DIM3:
TS1=<DIM1>
TS2=<DIM1×DIM2>
TS3=<DIM1×DIM2>DIM3>,
TS4=<DIM3>

The context analyzer 230 classifies each canonical message into all schemas that are defined by the dimensions present in the message. Each combination of dimension values per such tuple schema defines the specific tuple to which the event belongs. If such tuple exists, the event is added to the statistics of that tuple. Otherwise, a new tuple is created and the event is added to the new tuple. In both cases, the metrics measured on the event are added to the statistics of the tuple. For example, a tuple schema (TS1) includes the dimensions function and an error type, i.e. TS1=<function, error type>. The dimension values of TS, may be: T=<“getLocation,” “DB is not responding”>. A collection of measured values, e.g. an error rate, an application availability, each having a numeric value that can be statistically aggregated over time, is saved in cells. The statistics are later used for determining a baseline for each of the tuples, and define the normal context of the event. The operation of the context analyzer 230 is further discussed in U.S. patent application Ser. No. 11/092,447, assigned to common assignee, and which is hereby incorporated herein for all that it contains.

In accordance with the invention statistics are gathered on application errors on each tuple schema that includes an error dimension. Application errors are defined as a dimension and a tuple schema in the system 200. For example, an error dimension is calculated from the “return code type” which includes the application errors returned by the service to its client. The measured values (or statistics) associated with an error dimension include, but are not limited to, an error rate and the total amount. The error rate defines the number of errors of an error dimension aggregated over a specified time period. Statistic measures for the error rate, such as an average, a standard deviation, a minimum value, and a maximum value, may be also computed by system 200.

The context analyzer 230 may derive errors from messages using a set of extraction expressions each corresponding to a predefined dimension and, especially, to an error dimension. In an exemplary embodiment, an extraction expression is defined using an XML X-path expression. The context analyzer 230 applies the extraction expressions to the collected messages to extract the dimension values. The context analyzer 230 may also derive errors from error fields in the messages. The error fields are selected by users, e.g. IT personnel, on the fly. Errors included in a message generally contain an error code and, description. For error dimensions, the extracted dimension values are an error code and preferably, an error description. The error description is parsed to determine the error name, e.g. “DB is not responding.” Additionally, the error rate, i.e. the measure value of an error dimension, and its statistical measures are calculated and kept together with the dimension values in a cell. Each of the statistics variables is calculated for a specified and configurable time period.

The context analyzer 230 is also capable of associating errors with transaction instances. The context analyzer 230 analyzes the context of both messages and transaction instances composed of these messages. Thus, discovered errors can be associated with transaction instances, and thus transactions. By relating messages, as well as transactions to detected errors, the system 200 provides a reliable indicator of the IT health.

For predicting failures in the monitored enterprise application, the baseline analyzer 250 compares the current error rate against its normal rate, hereinafter referred as “the norm.” The norm determines the behavior of the enterprise application and whether that behavior is considered correct. As an example, the norm may determine the allowable maximum number of errors returned by a calling service per a request type. The norm may be predetermined by the user as a constant threshold value, a threshold having variable value, or dynamically determined by the baseline analyzer 250.

By comparing measured values to the norm, a scoring for a tuple is calculated based on the statistical distance of the error rate from an expected normal value. The results of the scoring may be categorized as a normal, a degrading, or a failure state. If the baseline analyzer 250 detects a deviation from a norm, an alert is generated and sent to the GUI 270 for presentation. Alerts can also be sent to an external system including, but not limited to, an email server, a personal digital assistant (PDA), a mobile phone, and the like. The baseline analyzer 250 also generates a plurality of analytic reports for specified periods of time, and a plurality of views that enable the user to view the state and statistical measures calculated for each combination of error groups over time.

In one embodiment of the invention, the baseline analyzer 250 may operate as a verification engine. In this embodiment, the verification engine compares the application errors, or the error rate, to a predefined set of rules. If one of the rules is triggered then an alert is generated. An example of such a rule is: generate an alert if at least one application error was detected between 10:00 am and 11:00 am.

In one embodiment of the invention, the baseline analyzer 250 generates real-time actionable data for the users, e.g. IT personnel. The actionable data are generated, and presented by GUI 270, in a format and context that allows users to perform their roles within the business process. It is important that the actions triggered by the data occur in a timely manner to have the greatest impact on the business.

In accordance with an exemplary embodiment of the invention, tuples may be categorized according to the error dimensions, into error groups. An error group includes a different class of errors that identifies the error source, for example, application errors, infrastructure errors, function errors, and so on. For each error group a decisive level is assigned. The decisive level determines whether or not the errors in the group are critical for the successful operation of the monitored enterprise application. The criteria for categorizing the errors and the decisive levels are predefined by the system 200 and can be also defined by the user.

The baseline analyzer 250 may automatically generate the norm, adapted to typical or seasonal behavior patterns. The baseline analyzer 250 uses historic statistics of a plurality of content characteristics to determine expected behavior in the future. The methods used by the baseline analyzer 250 to determine the norm are described in U.S. patent application Ser. No. 11/093,569, assigned to common assignee, and which is hereby incorporated herein for all that it contains.

The GUI 270 presents the actionable data generated by the baseline analyzer 250. Specifically, the GUI 270 displays to the user a constant status of the monitored services in a dashboard, alerts, analytical reports for specified periods of time, and the dependencies between monitored entities. This enables the user to locate the cause of failures in the monitored enterprise application. The GUI 270 also enables the user to view the state and statistics variables that were calculated over time. The invention provides multiple different views of the calculated metrics, and statistics variables are provided. These views include at lease a matrix view and a deviation graph view.

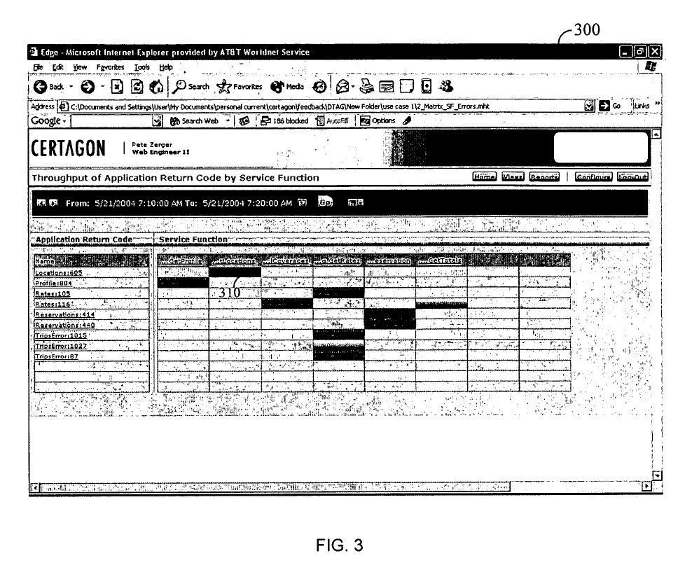

FIG. 3 shows an exemplary and non-limiting matrix view 300. The matrix view 300 provides a view at a glance of the scoring of a single error group that includes errors classified as application errors. The rows of the matrix view 300 list the values of a single attribute e.g. an application return error, while the column lists the values of a related transaction. Each cell shows the scoring state for the crossed values of the independent and dependent attributes. The scoring states normal, degrading, and failure are presented as a green cell, a yellow cell, and a red cell, respectively. For example, the cell 310 indicates a failure in the transaction “getLocations” with the return error code “location605.”

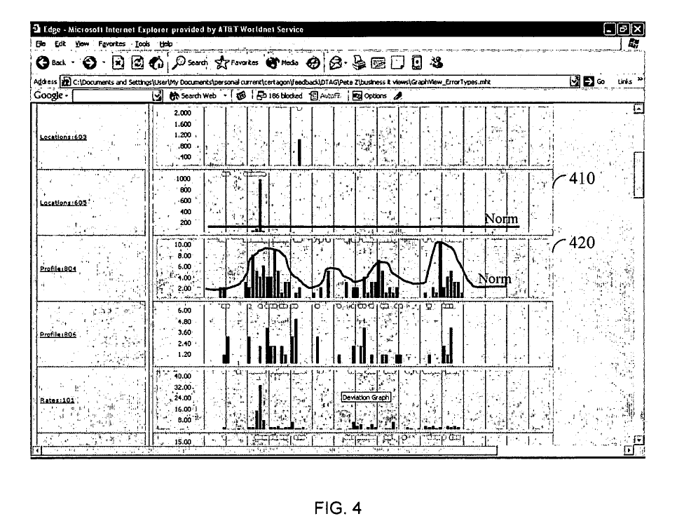

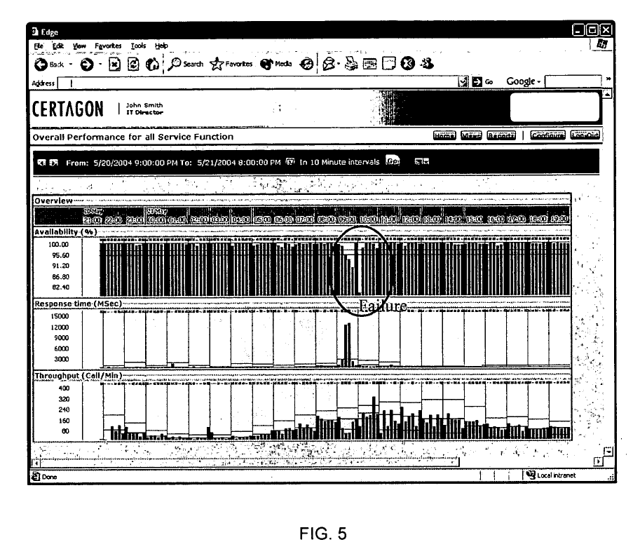

FIG. 4 shows an exemplary and non-limiting deviation graph view 400. The graph view 400 provides a series of graphs, each showing the error rate measured for the errors depicted in FIG. 3. The graph preferably displays the baseline and the range of normal and abnormal values. As shown in the graph 410, a spike in the measured error rate of the error code “location605” is discovered in certain time period of the operation of the monitored application. This is a significant deviation from the norm determined for the type error. This behavior provides a good indication to a future failure. In fact, a deviation graph view 500, provided in FIG. 5, shows a sharp fall in the application availability as detected immediately after the occurrence of the spike in the measured error rates. On the other hand, the deviation graph view 420 displays a burst of errors detected for the error code “profile804” during a certain time period of the operation of the monitored application. This represents a normal behavior of the application and, thus, a failure notification is not generated in this case. It is clearly understood from this example that the disclosed invention can use the application errors as a predictive metric.

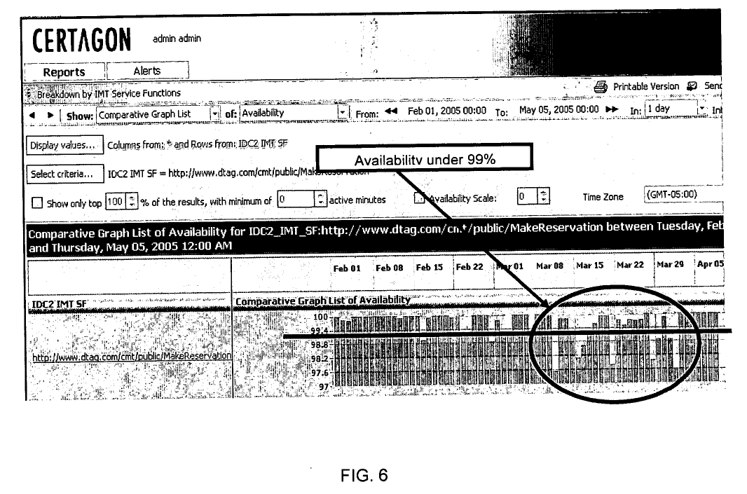

FIG. 6 shows another exemplary and non-limiting graph view 600 generated by the GUI 270. The Graph view 600 depicts the availability of a “MakeReservation” function of an exemplary car rental system. As can be seen, the availability 610 of this critical function is often below 99% per day. In this case, each failure to respond to a reservation request is tied directly to revenue loss. In other cases, the relationship can be less direct. Still, indirectly, any application failure affects the revenue and quality of service. As opposed to prior art solutions, the invention provides a clear indication on functional availability and, by that, significantly reduces revenue loss to enterprises.

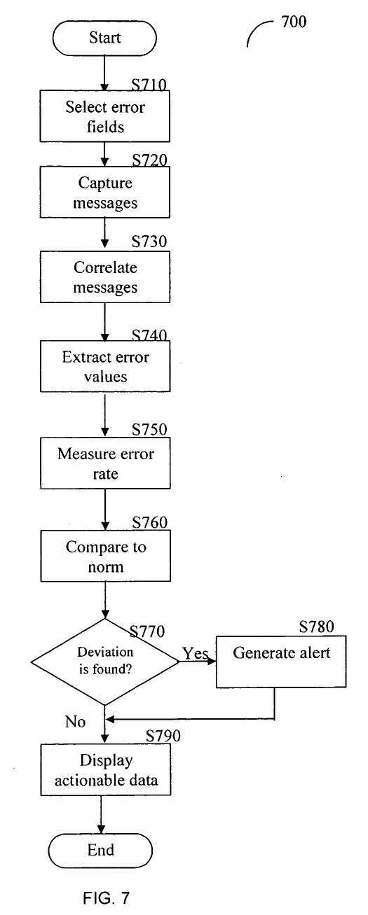

FIG. 7 a non-limiting flowchart 700 describing the method for employing application errors as a predictive metric in accordance with an exemplary embodiment of the invention. At step S710, the user designates, on the fly, error fields in messages exchanged between the various components of the monitored system. The configuration of these error fields is performed by application support personnel, and does not require the intervention of the software developers. When monitoring a standard protocol, for example, BPEL or FIXML the automated monitoring system 200 is pre-configured to recognize their standard return codes.

At step S720, raw messages exchanged between the different components of the monitored enterprise application are captured and only the parameters of interest including, but not limited to, return codes are extracted from the messages for generating light weight messages. These messages may be sent to a transaction correlator. At step S730, independent messages collected from independent application's components may be assembled into transaction instances.

At step S740, the context of the collected messages is analyzed for the purpose of detecting application errors in the monitored messages and transaction instances.

At step S750, the error rate and total number for each error value is calculated. Optionally, other statistical measures of the error rate are also calculated. In an exemplary embodiment of the invention, error values, the measured error rate, and other statistical measures are kept in cells, as described in greater detail above.

At step S760, the calculated error rate of respective error values are compared to a range band, which defines the norm of that error in the monitored message or transaction. At step S770, a check is made to determine if the error rate for an error value deviated from its expected value, as defined by the norm and, if so, at step S780 an alert is generated and sent to the user. Otherwise, at step S790, information about failures detection, as well as application errors and performance evaluation, is displayed to the user through a series of GUI views. It should be noted that an alert is generated depending on the statistical deviation from the norm.

It should be appreciated by a person skilled in the art that a key advantage of the invention is the ability to discover application error codes automatically, learn their normal distribution and determine whether the discovered errors can induce a system failure. This is achieved by comparing the error rate of errors associated with a transaction to the norm.

The invention has been described with reference to a specific embodiment, in which the automated monitoring system is used as a stand alone system. Other embodiments will be apparent to those of ordinary skill in the art. For example, the invention described herein can be adapted to embed with network appliances, such as wired or wireless bridges, routers, hubs, gateways, and so on. In this embodiment, the invention can be used to detect errors in messages transferred through or generated by the network appliances.

In other embodiments, the invention can be used for application messages routing and provisioning.

The values in the text and figures are exemplary only and are not meant to limit the invention. Although the invention has been described herein with reference to certain preferred embodiments, one skilled in the art will readily appreciate that other applications may be substituted for those set forth herein without departing from the spirit and scope of the present invention. Accordingly, the invention should only be limited by the claims included below.

1. An automated apparatus for discovering and using application errors as a metric for overall measuring of enterprise applications health comprising:
a plurality of data collectors for capturing cross-application messages;
a context analyzer for deriving application errors from said messages; and
a baseline analyzer for predicting failures in a monitored enterprise application.

2. The apparatus of claim 1, further comprising:
a graphical user interface (GUI) for displaying graphical views related to said application errors.

3. The apparatus of claim 1, further comprising:
a transaction correlator for correlating independent cross-application messages into a transaction instance.

4. The apparatus of claim 3, said context analyzer measuring a plurality of measured values for each of a plurality of types of error.

5. The apparatus of claim 4, wherein each of said plurality of measured values comprises any of:
an error rate, a throughput, a response time, a monetary value, and application availability.

6. The apparatus of claim 4, said context analyzer comprising:
means for deriving said application errors by applying a set of extraction expressions to said cross-application messages.

7. The apparatus of claim 1, said baseline analyzer generating a plurality of norms, wherein each of said plurality of norms determines behavior of a respective error type.

8. The apparatus of claim 7, said baseline analyzer performing failure prediction, wherein said failure prediction is performed by comparing an error rate of a respective error type to said norm.

9. The apparatus system of claim 1, said baseline analyzer further comprising:
a verification engine.

10. The apparatus of claim 9, said verification engine generating alerts if said error rate triggers a predefined rule.

11. The apparatus of claim 1, wherein locations of error fields in said cross-application messages are user designated.

12. The apparatus of claim 11, wherein said designation of error fields is performed as said cross-application messages are captured by said plurality of data collectors.

13. The apparatus of claim 1, wherein said enterprise application comprises a composite application.

14. The apparatus of claim 13, said cross application messages comprising:
messages in a format compliant with and of the following protocols:
a simple object access protocol (SOAP), a hypertext transfer protocol (HTTP), an extensible a markup language (XML), a Microsoft message queuing (MSMQ), a Java message service (JMS), and an IBM Web-Sphere MQ.

15. A computer implemented method for automatically discovering and using application errors as a metric for overall measuring of enterprise applications health and their functional health, comprising the steps of:
capturing cross-application messages for a monitored enterprise application;
analyzing context of said cross-application messages to derive application errors;
measuring a plurality of values for each of a plurality of types of application errors;
comparing said measured values for a respective error type to a norm; and
generating an action based on the comparison results.

16. The method of claim 15, further comprising the step of:
correlating said cross-application messages into a transaction instance.

17. The method of claim 16, said cross application messages comprising:
messages in a format compliant with at least one of the following protocols:
a simple object access protocol (SOAP), a hypertext transfer protocol (HTTP), an extensible markup language (XML), a Microsoft message queuing (MSMQ), a Java message service (JMS), and an IBM Web-Sphere MQ.

18. The method of claim 15, each of said plurality of measured values comprising of:
an error rate, a throughput, a response time, a monetary value, application and availability.

19. The method of claim 15, said analyzing step further comprising the step of:
applying a set of extraction expressions to said cross-application messages.

20. The method of claim 15, wherein said norm determines behavior of a respective error type.

21. The method of claim 20, said comparing step further comprising the step of:
comparing said measured values to a predefined set of rules.

22. The method of claim 21, said generating step further comprising the step of:
generating alerts if at least one of said predefined set of rules is triggered.

23. The method of claim 20, wherein locations of error fields in said cross-application messages are user designated.

24. The method of claim 23, wherein said designation of error fields is performed as said cross-application messages are captured.

25. The method of claim 15, wherein said enterprise application comprises a composite application.

26. The method of claim 15, wherein actionable data are displayed to a user through at least one graphical user interface (GUI) view.

27. The method of claim 25, further comprising the step of:
automatically discovering application errors using a plurality of performance indicators.

28. The method of claim 27, said discovering step comprising the steps of:
receiving said performance indicators; and
identifying application errors in said performance indicators.

29. The method of claim 1, further comprising the step of:
using said application errors as a predictive metric for application failures.

30. A computer software product readable by a machine, tangibly embodying a program of instructions executable by the machine to implement a process for automatically discovering and using application errors as a predictive metric for overall monitoring of enterprise applications and their functional health, the process comprising the steps of:
capturing cross-application messages for a monitored enterprise application;
analyzing context of said cross-application messages derive application errors;
measuring a plurality of values for each for a plurality of types of application errors;
comparing said measured values for a respective error type to a norm; and
generating an action data based on said comparison results.

31. The computer software product of claim 30, said process further comprising the step of:
correlating said cross-application messages into a transaction instance.

32. The computer software product of claim 31, said cross application messages comprising:
messages in a format compliant with at least one of the following protocols:
a simple object access protocol (SOAP), a hypertext transfer protocol (HTTP), an extensible markup language (XML), a Microsoft message queuing (MSMQ), a Java message service (JMS), an IBM Web-Sphere MQ.

33. The computer software product of claim 30, each of said plurality of measured values comprising any of:
an error rate, a throughput, a response time, a monetary value, and application availability.

34. The computer software product of claim 30, said analyzing step further comprising the step of:
applying a set of extraction expressions to said cross-application messages.

35. The computer software product of claim 30, wherein said norm determines behavior of a respective error type.

36. The computer software product of claim 30, said comparing step further comprising the step of:
comparing said measured values to a predefined set of rules.

37. The computer software product of claim 36, said generating step further comprising the step of:
generating alerts if at least one of said predefined set of rules is triggered.

38. The computer software product of claim 35, wherein locations of error fields in said cross-application messages are user designated.

39. The computer software product of claim 38, wherein designation of error fields is performed as said cross-application messages are captured.

40. The computer software product of claim 30, wherein said enterprise application comprises a composite application.

41. The computer software product of claim 30, wherein actionable data are displayed to a user through at least one graphical user interface (GUI) view.

42. The computer software product of claim 30, said method further comprising the step of:
automatically discovering application errors using a plurality of performance indicators.

43. The computer software product of claim 42, said discovering step comprising the steps of:
receiving said performance indicators; and
identifying said application errors in said performance indicators.

44. The computer software product of claim 30, said step for discovering application errors is executed by a network appliance.

45. The computer software product of claim 44, wherein said network appliance comprises any of:
a bridge, a router, a hub, and a gateway.

46. The computer software product of claim 30, further comprising the step of:
performing application messages routing and provisioning.
